(19) United States
(12) Patent Application Publication
(10) Pub. No.: US 2025/0208294 A1
(43) Pub. Date: Jun. 26, 2025

(54) AERIAL SCANNING INSTRUMENT WITH ATTITUDE ADJUSTMENT

(71) Applicant: LEICA GEOSYSTEMS AG, Heerbrugg (CH)

(72) Inventor: Werner KIRCHHOFER, Walzenhausen (CH)

(73) Assignee: LEICA GEOSYSTEMS AG, Heerbrugg (CH)

(21) Appl. No.: 18/970,369

(22) Filed: Dec. 5, 2024

(30) Foreign Application Priority Data
Dec. 21, 2023 (EP) 23219446.4

(51) Int. Cl. G01S 17/42; G01S 7/484; G01S 17/89

(52) U.S. Cl. CPC G01S 17/42; G01S 7/484; G01S 17/89

(57) ABSTRACT

A mobile scanning instrument configured to be mounted on a carrier and to acquire point cloud data representing a target area at an object distance whilst the carrier vehicle is travelling at a carrier velocity relative to the target area. The mobile scanning instrument comprises (i) a pulse source unit configured to generate scanning pulses with a pulse rate, and (ii) a beam deflection element configured to define an actual transmission direction of the generated scanning pulses, wherein the actual transmission direction varies along a scan pattern with a scan rate. The scanning instrument is configured to offset the scan pattern with a twist angle representing a rotation about a main axis and to optimize the twist angle based on an optimization target representing a point density and/or a homogeneity of the point cloud data.

### FIELD

The present disclosure relates to a structure and operation of a mobile scanning instrument configured to acquire a point cloud data representing a target area. The mobile scanning instrument is configured to be mounted to a carrier vehicle, in particular an aerial vehicle, an acquire the point cloud, while the carrier vehicle is travelling with a carrier velocity.

### BACKGROUND

To capture two- or three-dimensional or information on target area, in particular an urban or agricultural area, scanning methods are typically utilized. Ideally a homogenous, dense point cloud is provided. Generic scanning instruments scan the setting with a scanning beam, in particular a laser-beam, and determine the distance of object points based e.g. on time-of-flight measurement. The point cloud representing the setting is generated by combining the measured distance information with an emission angle of the scanning beam. The capturing of the point cloud might also be carried out during a spatial movement of the measuring apparatus. The own movement of the measuring apparatus, respectively the movement of a mobile carrier, has to be acquired and merged with the scan data. Especially for aerial scanning the fast movement of the carrier as well as the relatively long time-of-flight of the scanning pulses might limit the achievable quality of the point cloud. While the applicability of the present disclosure is not limited to the field of aerial scanning, many aspects will be illustrated by examples from aerial scanning. The specific features of other mobile scanning methods, e.g. car or rail based profiling, can be applied accordingly.

Aerial scanning is typically performed with instruments whose beam deflection element generates the scanning pattern by a rotating, e.g., a rotating prism, or an oscillating type of mode of beam deflection with respect to a main axis of the scanning instrument, the main axis defines a reference system. While for some embodiments the main axis corresponds to a physical rotation and/or a specific optical axis of the survey instruments an imaginary axis can also act as the main axis. The main axis is typically aligned to the Nadir (“straight down”) direction, while the rotation or swinging movement provides a scanning field of view in the range of 20-90°, more particularly 40-60°. Said scanning is performed by a mechanical element, i.e. scan rates above 150,000 rotation per minute or 250 Hz are currently not practicable.

The scanning instruments generates scan pulses in a periodic manner and transmits them with a pulse rate. For aerial scanning periodic manner is understood in a broad sense, i.e. the generation of the pulse might involve a periodic or pseudorandom modulation, or even a combination of both, e.g. as disclosed in EP 4 148 458 A1. Since the pulse generation is provided by purely electronic components, the practical limit of the pulse rate is set by the detection and assignment of the return pulses.

In the following the relevant resolutions in a generic high-resolution survey task will be illustrated by a simplified example. By way of example the scanning instrument provides a line pattern scanned unidirectionally along a circle with a scan rate of 200 Hz, a pulse rate of 2 MHz. The aircraft, as carrier vehicle is, travelling with 100 ms⁻¹ flight speed, i.e. the magnitude of the carrier velocity, and the flight height, which near the nadir corresponds to the object distance, is 500 m.

The line-to-line distance (d_{L2L}), or the distance between two scan lines, depends solely on the carrier velocity (ν) and the scan rate (fₛ):

d_{L2L}=v/fₛ=100 ms⁻/200 Hz=0.5 m

The point-to-point distance (d_{P2P}) depends on pulse rate (fₚ) and the scan rate (fₛ) and the object distance (h), under the above conditions it can be estimated as

d_{P2P}≈2πfₛ/fᵣh=6.283·200 Hz/2 MHz500 m≈0.3 m

The achievable point-to-point distance (d_{P2P}) is inversely proportional to the object distance (h). The line-to-line distance (d_{L2L}) however does not depend on the object distance. This means that the maximum resolution, in particular the maximum homogeneous resolution, is limited by the achievable line-to-line distance. The achievable line-to-line distance is however dependent on the carrier velocity, which is e.g. limited by the stall speed of fixed wing aircraft, and the scan rate. Moreover without improving the line-to-line distance (d_{L2L}) the surveyor cannot exploit the capabilities of improved electronics or higher performance aircraft.

Systems allowing higher flexibility in providing an effective line-to-line density are desirable. Among others such systems would profit from the development of faster laser sources/detectors as they would enable higher pulse rates.

### OBJECT

In view of the above circumstances, an object of the present disclosure is to provide more flexibility in designing a survey job by a mobile scanning instrument.

A particular object is to optimize the homogeneity and/or the point density of the point cloud data and/or the scan expense.

Another objective of the present disclosure is to expand the operational envelope of the survey systems, particularly for survey aircrafts by enabling higher flight speeds while maintaining the point spacing.

Another objective of the present disclosure is to reduce the required number of survey runs over the same target area, thereby reducing environmental burdens.

### SUMMARY

The present disclosure relates to a mobile scanning instrument configured to be mounted on a carrier vehicle and configured to acquire point cloud data representing a target area. The target area is located at an object distance from the mobile scanning instrument whilst the carrier vehicle is travelling at a carrier velocity relative to the target area.

From here on, unless otherwise specified, a mobile scanning instrument is understood to comprise elements configured to provide said mounting to the carrier vehicle. The mounting elements might provide an adjustable, in particular adjustable in a motorized fashion within a scanning task or in between two scanning task, orientation of the mobile scanning instrument with respect to the orientation of the carrier vehicle and/or the carrier velocity. The reference system of the mobile scanning instrument comprises a main axis of the scanning instrument. The main axis represents a direction of view.

The mobile scanning instrument comprises a pulse source unit configured to generate scanning pulses in a periodic manner having a pulse rate. Periodic in the sense of disclosure also comprises modulated sequences. The mobile scanning instrument also comprises a beam deflection element configured to define an actual transmission direction of the generated scanning pulses with respect to the main axis, wherein the actual transmission direction varies along a scan pattern in a periodic manner having a scan rate. Scan pattern in the sense of the disclosure corresponds to the above variation of the transmission direction. The point patterns actually generated on the target are a result of the interplay of the scan pattern, the actual generation of the pulses according to the specific pulse sequence and the target topography. By way of example, for many of the embodiments described, it is assumed that the pulse generation and beam deflection are strictly periodic. It is clear to those skilled in the art that this is merely for the sake of transparency and that neither the present disclosure nor the disclosed embodiments, unless expressly mentioned, are limited to such cases. The specific features of e.g. modulated pulse shall be applied accordingly.

By way of example the ensemble of the pulse source and the beam deflection element will also be referred to as transmission unit. For many of the disclosed embodiments the beam deflection element also interacts with the reflected scanning beam. The disclosure is, in principle, applicable with any detection arrangement including both embodiments wherein the beam deflection element interacts with the reflected beam and embodiments comprising a partly or fully separated detector beam path.

The mobile scanning instrument exhibits a main axis. In a general sense the main axis defines an instrument intern reference system. Moreover, the carrier velocity and the main axis define a moving external reference system. The main axis might correspond to a section of a beam path, in particular a section representing the beam entering a beam deflection element, and/or an imaginary beam path corresponding to an undeflected outgoing beam, and/or a time average of the actual transmission direction, and/or an average of the transmission directions of the transmitted pulses. The skilled person understands that many elements of the above list, referring to some praxis-relevant choice for the main axis, coincide for generic scanning instruments.

The scanning instrument is configured to offset the scan pattern with a twist angle representing a rotation about the main axis. Alternatively, if the carrier velocity is known, the orientation of the scan pattern is settable with respect to carrier velocity. The offsetting might be provided by a mechanical component rotating the beam deflection element/transmission element about the main axis. Alternatively, the offsetting is provided by changing an operational mode/operational parameter of the beam deflection element.

The scanning instrument is configured to perform a twist angle optimization algorithm. The twist angle optimization algorithm comprises (i) accessing input parameters comprising the pulse rate, the scan rate, the carrier velocity, and the object distance, (ii) providing an optimization target representing a point density and/or a homogeneity of the point cloud data, and (iii) providing an output twist angle based on the optimization target and the input parameters. It is self-explanatory for the skilled artisan that the utilization of numerals and letters does not represent e.g. a sequence of performing the steps. These and all further numbers do not represent a temporal and spatial connection, not even in the form of a preferred sequence, and merely serve the purpose of readability. Said actions might be performed in any reasonable way, in particular as continuous adjustment.

Owing to the twisting, at least in a middle portion of the swath, an effective line-to-line distance (d_{L2L,eff}), i.e. a distance in a direction perpendicular to the scan direction, will be d_{L2L,eff}=d_{L2L}·cos(α), wherein α is the angle between the scan direction and the carrier velocity and d_{L2L} is the line-to-line distance measured in the direction of the carrier velocity. In other words, the twisting enables an overcoming of the limits of the velocity of the mechanical elements.

The optimization target might comprise preferred intervals, e.g. “a field of view 25-40°” and/or “a swath width 150-250 meters”, maximization targets, minimization targets or threshold levels, e.g. “maximize the point density” and/or “at least 5 points per m²”, a constraint regarding the scan or pulse rates, or forcing relationship between different parameters and/or navigational targets, e.g. “homogeneous point density” and/or “scanning direction perpendicular to carrier velocity”. The skilled person could provide many sensible combinations and alternatives based on the above non-exhaustive list.

In some specific embodiments, the mobile scanning instrument is configured to be mounted to an aircraft. The carrier velocity is a flight velocity with respect to the ground. In some specific embodiments, the main axis corresponds to a nadir direction. In some specific embodiments the carrier is one of (i) a helicopter, (ii) a light fixed wing aircraft, having a gross take-off weight below 6000 kg, and (iii) a large UAV, having a weight over 150 kg. While not limited to the disclosure can be beneficially combined with new, higher performance survey aircrafts.

In some embodiment, the beam deflection element comprises a first wedge and a second wedge mounted along the main axis. The first wedge is configured to rotate with a first wedge rate. The second wedge configured to rotate with a second wedge rate, such that a ratio first and the second wedge rates is a proper fraction, in particular a root of unity. Consequently, the scan rate corresponds to a largest common divisor of the first and second wedge rates.

In some specific embodiments, the wedges are designed to provide a generalized Risley prism pair, more particularly a prism pair with identical wedges configured to provide linear, circular, and rose patterns depending on the ratio of the wedge rates. Alternatively, the wedges are designed to provide a prism pair with dissimilar wedges configured to provide elliptical, circular, and rose patterns depending on the ratio of the wedge rates.

In some specific embodiments, the mobile scanning instrument is configured to provide the twist angle based on a wedge phase shift representing a phase difference between a rotation of the first wedge and a rotation of the second wedge. One advantage of the above generalized Risley prism pair is the ability to provide the twist angle without rotating the scanning instrument. I.e. the twist angle can be constantly monitored and adjusted during a scan task. Alternatively or additionally, the twist angle might be varied depending on the partial scan task, i.e. when a single scanning task involves both urban and landscape scanning and/or overview survey from high altitude and high resolution scanning of an area of interest.

In some embodiments, the mobile scanning instrument is configured to provide a twist angle interval, wherein the scanning instrument is configured to offset the scan pattern with any twist angle within said interval. In some specific embodiments the mobile scanning instrument is configured to provide any possible twist angle in the 0-360° interval in a stepless manner. Alternatively, the mobile scanning instrument might provide a set of selectable twist angles, comprising a limited number, in particular less than six, preset twist angles and means for selecting one twist angle from the set of selectable twist angles, in particular as a hardware switch or a software switch embodied as a dropdown menu.

In some embodiments, (i) the scan pattern is a line pattern, (ii) the scan rate and the carrier velocity define a line-to-line distance, (iii) the pulse rate, the scan rate and the object distance define a point-to-point distance, and (iv) the optimization target is a threshold homogeneous point density of the point cloud data. It is clear that line pattern in the sense of the disclosure covers both unidirectional scanning, resulting a point pattern comprising parallel lines and oscillating patterns resulting in a generalized zig-zag point patterns. In alternative embodiments the scan pattern is an elliptical pattern. The specific features corresponding to line-to-line and point-to-point distance can be defined accordingly. Particularly a linear displacement between point corresponding to the same scan phase might define an equivalent of the line-to-point distance.

In some specific embodiments, the twist angle optimization algorithm comprises (i) determining an effective line-to-line distance based on the line-to-line distance and the twist angle, (ii) providing the optimal twist angle based on the effective line-to-line distance and the point-to-point distance, in particular by selecting the twist angle setting the effective line-to-line distance equal to a maximal point-to-point distance or to point-to-point distance corresponding to a target point density. In other words, the highest homogeneous point density is either limited by the effective line-to-line distance, which might be the case for low altitude scanning or by the point-to-point distance, which might be the case for high altitude scanning. The twist angle optimization algorithm provides a twist angle for which the two coincide, thus no “empty optimization” takes place. Instead of the point-to-point distance an effective point-to-point distance, considering a resolution loss due to post processing, can be equally used. Resolution can be lost, for example, due to artifact removal or smoothing.

In some embodiments, the mobile scanning instrument comprises a task recognition functionality. The task recognition functionality is configured to (i) determine a type of the scan task, in particular by determining a representative object distance variation, and (ii) provide an assessment on the optimization target based on the determined scan task. The scanning instrument might be configured to provide an assessment regarding the scan task, whether a landscape or urban scanning is performed, whether a high- or low altitude scan is performed, whether the flight speed is high etc. Such data can be provided by the operator; however it may equally be recognized from the point cloud data itself.

In some specific embodiments, the optimization target comprises maximizing an effective swath width for scan tasks with representative object distance variation is low, e.g., below 10 meter/100 meter. The effective swath width is the extent of the scan pattern perpendicular to the carrier velocity.

In some specific embodiments, the optimization target comprises maximizing a homogeneous point density of the point cloud data for scan tasks with representative object distance variation above 10 meter/100 meter. The homogeneous point density of the point cloud data might be provided by setting the effective line-to-line distance equal to a maximal point-to-point distance or a point-to-point distance corresponding to a point density target.

In some embodiments, the mobile scanning instrument is configured to acquire point cloud data with the scan rate of at least 10 Hz, in particular 50 Hz. In some specific embodiments, the mobile scanning instrument is configured to acquire point cloud data with the scan rate of at least 200 Hz.

The present disclosure also relates to a method of surveying by a mobile scanning instrument mounted on a carrier vehicle travelling with a carrier velocity a target area at an object distance from the mobile scanning instrument. The method comprises (i) generating scanning pulses in a periodic manner having a pulse rate, (ii) transmitting the generated scanning pulses along an actual transmission direction with respect to a main axis, wherein the actual transmission direction varies along a scan pattern in a periodic manner having a scan rate, (iii) acquiring return pulses from the target area and providing return pulse data regarding the acquired return pulses, (iv) deriving the point cloud data representing the target area based on the return pulse data, (v) performing a twist angle optimization. The twist angle optimization comprises (a) accessing input parameters comprising the pulse rate, the scan rate, the carrier velocity, and the object distance, (b) providing an optimization target representing a point density and/or a homogeneity of the point cloud data, (c) providing an output twist angle based on the optimization target and the input parameters, wherein a twist angle represents an offsetting of the scan pattern by a rotation about the main axis, and (d) setting the twist angle to the output twist angle.

In some embodiments of the method, the optimization target is a highest achievable homogeneous point density of the point cloud data. In other words, equal point spacing it desired at max collection velocity to overcome the limitations of the scan rate.

In some embodiments, the method further comprises a task recognition. The task recognition comprises (i) determining a type of the scan task, in particular by determining a representative object distance variation, and (ii) providing an assessment on the optimization target based on the determined scan task.

In some specific embodiment of the method, feedback data is provided to a training procedure. The training procedure is based on a machine learning algorithm and providing update information for the task recognition. The feedback data is provided by (i) explicit feedback by means of the feedback procedure, in particular by an operator of the mobile scanning instrument, and/or (ii) implicit feedback. The implicit feedback can be based on an interpretation of a lack of explicit feedback as a confirmation of the assignment and/or a comparison of actual point cloud data, in particular a line-to-line distance, point-to-point distance, or swath width, with the assessed optimization target.

In some embodiments of the method, (i) the surveying is an aerial scanning, (ii) the carrier velocity is a flight velocity, (iii) the main axis corresponds to a nadir direction, and (iv) the method is performed relative to a reference frame defined by the flight velocity and the nadir direction, in particular in a zero-twist state the scan pattern has a maximum extension in a direction perpendicular both to the nadir direction and the flight velocity. In other words, the zero-twist state corresponds to a swath width optimized aerial scanning, in particular a landscape scan.

In some embodiments, the method further comprises (i) providing a pulse modulation arrangement, wherein the pulse modulation arrangement comprises (a) a pseudorandom component, and/or (b) a geometry dependent component provided on the basis of the actual transmission direction, and (ii) modulating the generation of the scanning pulse based on the pulse modulation arrangement. In other words, the inventive method can be performed with modulated pulse trains. The modulated pulse train might be configured to provide an improved homogeneity of the point cloud, in particular by compensating the time-of-flight variation of the pulses in dependence of the actual transmission direction and/or by compensating the reduced ground velocity of the scan pattern at the border of the swath. The modulated pulse train might also be configured to provide an MPiA disambiguation. The modulation might also be configured to fulfill both of these and/or further requirements.

In some embodiments, the method further comprises a post-processing. The post processing comprises a step of discarding and/or smoothing a major portion of the point cloud data in order to improve homogeneity. The pulse rate is set to oversample the target area thereby allowing the post processing to be performed. In other words, point-to-point distance can deliberately set to be lower than the line-to-line distance.

In some specific embodiments, the point-to-point distance might be set to be a unit fraction of the line-to-line distance, i.e. 1:2, 1:3 and a respective number of points might be discarded/smoothed. Alternatively, the pulse rate might be set to be the highest and the homogeneity is ensured by providing virtual object points as mean points derived from a plurality of measured object points.

The present disclosure also relates to a computer program comprising program code and stored on a machine-readable medium or embodied by an electromagnetic wave. The computer program comprises a program code segment and has computer-executable instructions for performing a twist angle optimization algorithm for a mobile scanning instrument mounted on a carrier vehicle. The mobile scanning instrument is configured to (i) generate scanning pulses in a periodic manner having a pulse rate, (ii) transmit the generated scanning pulses along an actual transmission direction with respect to a main axis, wherein the actual transmission direction varies along a scan pattern in a periodic manner having a scan rate, (iii) acquire return pulses from a target area and providing return pulse data regarding the acquired return pulses, and (iv) derive point cloud data representing the target area based on the return pulse data. The mobile scanning instrument is particularly an embodiment of the inventive mobile scanning instrument.

The twist angle optimization algorithm comprises (i) accessing input parameters comprising the pulse rate, the scan rate, a carrier velocity, and an object distance, (ii) providing an optimization target representing a point density and/or a homogeneity of the point cloud data, (iii) providing an output twist angle based on the optimization target and the input parameters, wherein a twist angle represents an offsetting of the scan pattern by a rotation a main axis.

The computer program might be realized as a part of generic driver of the mobile scanning instrument configured to control further aspects of the mobile scanning instrument. Alternatively, the computer program might also be realized as a standalone product configured substantially to for performing a twist angle optimization algorithm.

### BRIEF DESCRIPTION OF THE DRAWINGS

By way of example only, specific embodiments will be described more fully hereinafter with reference to the accompanying figures, wherein:

FIG. 1 depicts the schematics of an aerial scanning of target area.

FIG. 2 depicts a few point patterns with respect to the main axis (a-e) and the target area (f-j).

FIG. 3 depicts a schematic of a scanning instrument and a possible realization of a beam deflection element.

FIG. 4 depicts schematically an offsetting of an elliptical scan pattern.

FIG. 5 schematically depicts the effect of offsetting a linear scan pattern with a twist angle on the homogeneous point density and the swath width.

FIG. 6a schematically depicts, by a flowchart, some key aspects of the twist angle optimization algorithm.

FIG. 6b schematically depicts an algorithm for providing a homogeneous point density by adjusting the twist angle and the pulse rate.

### DETAILED DESCRIPTION

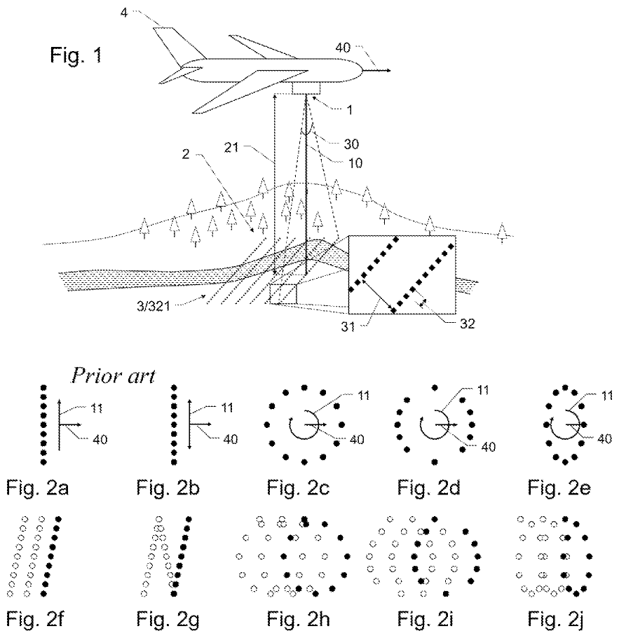

FIG. 1 shows a mobile scanning instrument 1 carried by an aircraft 4 to acquire a point cloud data from a target area 2 while the aircraft 4 travels with a carrier velocity 40 relative to the target area 2. The mobile scanning instrument 1 is usually mounted together with further surveying elements and cameras facing downwards or to oblique direction. The main axis 10 of the mobile scanning instrument 1 is aligned in a known way relative to the carrier velocity 40. In the depicted embodiment it is aligned to the nadir. The object distance 21 between the target area 2 and the scanning instrument 1 might be defined, as depicted, with respect to the main axis 10. Alternative mountings, e.g. the main axis 10 could point obliquely to a side of forwards or backwards with respect to the carrier velocity 40 are also within the sense of the present disclosure.

The scanning instrument 1 is configured to provide a scan pattern 3, depicted as a line pattern, represented by the resulting point pattern 399. While the present disclosure is not limited to such line patterns, for the sake of transparency many features of present disclosure will be illustrated using a line pattern. The aspects of further scan patterns, in particular elliptical patterns might be applied accordingly. The key parameters of such scan patterns are a field of view 30 defining a swath width, a line-to-line distance 31 of the resulting point pattern 399, and a point-to-point distance 32 of the resulting point pattern 399. Throughout the description field of view 30 is defined with angular dimension, while swath width, line-to-line 31 and point-to-point distance 32 is defined with linear dimension. This serves transparency reasons only and suitable alternative conventions are also applicable. While FIG. 1 is a schematic representation and not to scale, the reasonably achievable point-to-point distance 32 is generally smaller than line-to-line distance 31.

FIG. 2 depicts non-exclusive examples of point patterns. The top row (FIG. 2 a-e) depicts the point pattern with respect to the main axis, i.e. as a stationary pattern. The bottom row (FIG. 2 f-j) depicts the respective patterns with respect to the target area, i.e. considering the carrier velocity 40. Full circles represent the last scanning period, while previous scan periods are marked with empty circles.

The first pair (a-f) is a line pattern scanned in a single scan direction 11. The second pair (b-g) corresponds to a zig-zag pattern, i.e. the scan direction 11 reverses during the scanning. The third pair (c-h) is a circular pattern with strictly periodic pulse rates, i.e. the time interval between two pulse transmission is always the same. The fourth pair (d-i) is a circular scan/point pattern; however, the pulse rate is modulated to provide a uniform distance between the rows of the pulses. In the sense of the disclosure a pattern according to the fourth pair also possess pulses generated in a periodic manner. The fifth pair (e-j) represent an elliptical pattern.

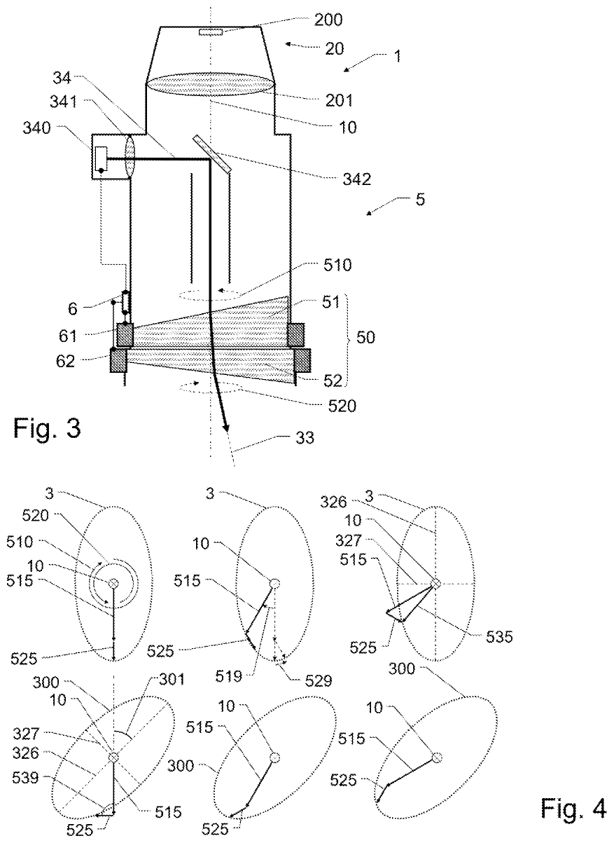

FIG. 3 schematically depicts a scanning instrument 1 having a transmission unit 5 with a beam deflection element 50 comprising a first wedge 51 and a second wedge 52. By way of example the first 51 and second wedges 52 with different geometry is shown, such beam deflection elements 50 are configured to provide an elliptical scan pattern. With two optically identical wedges, i.e. a Risley prism pair, linear scan patterns could be provided. For transparency reasons the former embodiment will be discussed in more detail. This, however, shall not be construed in a limiting manner. Specific aspects are applicable to embodiments with identical wedges. Moreover, the disclosure in general, is also applicable with scanning instruments 1 based on other beam deflection elements 50, such as galvo-mirrors or polygon mirrors.

The transmission unit also comprises a pulse source 340 and focusing/collimating elements 341 as well as a mirror 342 to steer the beam towards the beam deflection element 50. A section of the beam path 34 corresponds to the main axis 10 of the transmission unit 5 or the scanning instrument 1. The beam deflection element 50 defines the actual transmission direction 33 of the scanning pulses. A periodic variation of actual transmission direction 33 along the scan pattern is provided by rotating 510,520 the first 51 and second wedges 52 with the respective motors 61,62.

The scanning instrument 1 also comprises a detection unit 20, with a sensing element 200 and appropriate focusing optics 201. The detection unit 20 is configured to acquire return pulses from the target area (not shown). The scanning instrument comprises a computing unit 6, the computing unit is configured to control the pulse source 340, the motors 61,62 driving the wedges 51,52 and to access data from the detection unit (not shown).

The skilled person understands that the above schematic representation might omitted some features and/or displayed said features in simplified manner. Moreover, some of the depicted features, while advantageous, may not be strictly necessary to realize the disclosure. These features are not to be construed as limiting the claimed subject matter, which is defined only by the claims.

FIG. 4 illustrates the concept of offsetting the scan pattern 3,300 by a twist angle 301, corresponding to a rotation about the main axis 10. By way of example the main axis 10 points towards the nadir. By way of example FIG. 4 interpreted based on the principles of scanning instrument analogous to the one illustrated in FIG. 3. As will be shown such scanning instruments are well-suited to carry out the disclosure as they can provide the twist angle 301 without any further mechanical components. The present disclosure can, nevertheless, be performed by scanning instrument based on other working principles. The disclosure can be applied particularly with instruments where the beam deflection element or the housing of the scanning instrument is mechanically rotated by an angle corresponding to the twist angle 301.

The scanning instrument is configured to provide a first beam deflection angle 515 and a second beam deflection angle 525. The net beam deflection angle 535, is the vector sum of the first 515 and second beam deflection angles 525.

The beam deflection angles 515,525 are rotated 510,520 by the respective first 519 and the second rate 529 in directions opposite to each other. The magnitude of the first 519 and second rates 529 are equal. This means that during one complete rotation the first 515 and second deflection angles 525 experience all orientation differences as the net deflection angle 535 scans an elliptical shaped second scan pattern 3,300. The long axis 326 of the ellipse corresponds to a sum of the deflection angles 515,525, while a short axis 327 corresponds to a difference of the deflection angles 515,525.

The top row depicts a situation where the deflection angles 515,525 are in phase to each other at the first panel, while the bottom row depicts a situation where a wedge phase shift 539 is introduced between the two beam deflection angles 515,525. The shape of the scan patterns 3,300, characterized by the long 326 and short axes 327 are identical. The offset scan pattern 300, is however offset by rotation with a twist angle 301 about the main axis 10. The twist angle 301 in the depicted embodiment is the half of the wedge phase shift 539. The offsetting of a linear scan pattern, provided by a Risley prism pair, can be performed in an analogous manner.

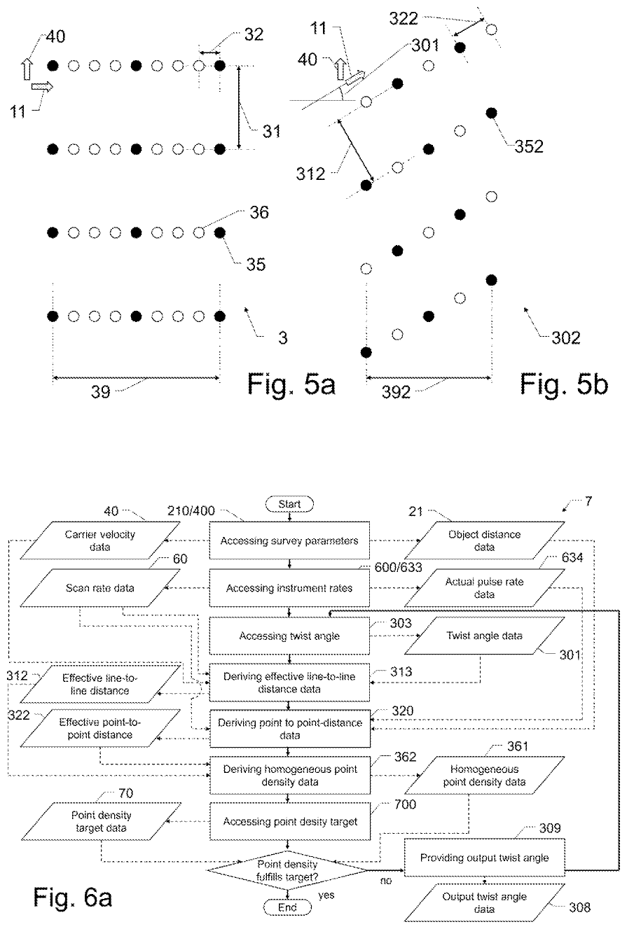

FIGS. 5a and 5b illustrates the effects of offsetting a linear scan pattern 3,302 by a twist angle 301 on the line-to-line distance 31 respectively the effective line-to-line distance 312, i.e. the homogenous point density, and the swath width 39,392. By way of example FIG. 5a shows a situation, wherein the scanning is performed by a fixed wing aircraft travelling with a carrier velocity 40 and the scan direction 11 is set to be perpendicular to the carrier velocity 40.

The point-to-point distance 32 is limited by the achievable pulse rate and the flight height, the latter can be varied depending on the task, while the former depend on the performance of electronic components. The line-to-line distance 31 depends on the scan rate and the carrier velocity 40, the latter is constrained by aircraft type, while the former depend on the performance of mechanical components.

This means that for high resolution scanning a situation as depicted in FIG. 5a, representing a zero-twist state, is often encountered. In the zero-twist state the scan pattern 3 has a maximum extension a direction perpendicular both to the nadir direction and the direction of the carrier velocity 40. The object points 35 of the homogeneous point cloud are represented by the filled circles. Their density is limited by the achievable line-to-line distance 31. The empty circles relate to further object points 36, which are typically measured for an improved filtering of the point cloud, however, do not contribute to the resolution. In other words, the pulse rate is set to oversample the target area, which allows a post processing to be performed. The point-to-point distance 32 is typically set to correlate with the line-to-line distance 31.

In FIG. 5b the scan direction 11 is offset by the twist angle 301. The effective line-to-line distance 312 in the twisted pattern 302 is reduced by a cosine of the twist angle 301. This allows an increased density for the object points 352 of the homogeneous point cloud. The price to be paid is the reduction of the swath width 392 by the cosine to the square of the twist angle 301. However, this is often an acceptable compromise, especially for urban survey, because the advantages of a large swath width 392 cannot be exploited due to the shadow effects of the buildings. The effective point-to-point distance 322 is set to correlate with the effective line-to-line distance 312.

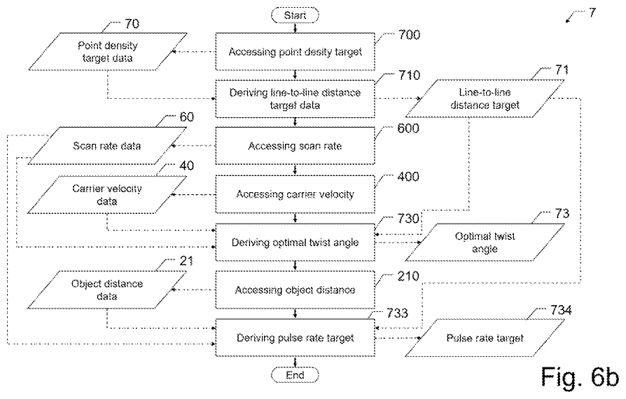

FIG. 6a schematically depicts, by a flowchart, a first exemplary embodiment of the twist angle optimization algorithm 7. Command/flow-lines show as bold and data-lines as dashed arrows. The skilled person understands that the depicted flowcharts focus on the features of the disclosure and the actual embodiments comprise further, non-depicted elements, in particular command or data elements and/or data transfer lines. Moreover, command or data modules might be depicted in a simplified form due to reasons of clarity and conciseness.

In the depicted embodiment accessing the input data is realized in two steps. First the survey parameters, including the object distance data 21 and the carrier velocity data 40 is accessed 210/400. Further survey parameters, in particular an expected variation of the object distance 21, might also be accessed. This is followed by accessing 600/633 the instrument rates, i.e. the scan rate 60 and the actual pulse rate 634. Finally, the twist angle 301, in particular the orientation of the scan pattern with respect to the carrier velocity 40, is accessed 303. From the above parameters the effective line-to-line 312 and effective point-to-point distances 322 are derived 313/320. The achievable homogeneous point density data 361 is derived 362 based on the effective line-to-line 312 and point-to-point distances 322. The homogeneous point density 361 is then compared with a point density target data 70 provided 700 e.g. by a manual input or as a scan task related target. If the homogeneous point density 361 does not correspond to the point density target 70 an output twist angle data 308, i.e. commands for adjusting the twist angle 301, is provided 309. It is clear for the skilled person that the depicted twist angle optimization algorithm 7 is effectively applicable if the homogeneous point density 361 is limited by the effective line-to-line distance 312.

FIG. 6b schematically depicts, by a flowchart, a second exemplary embodiment of the twist angle optimization algorithm 7. In this embodiment the goal is to provide a point cloud according to point density target 70. First the point density target 70 is accessed 700. A line-to-line distance target 71 is derived 710 based on the point density target 70. The system accesses 400,600 the carrier velocity 40 and the scan rate 60. The optimal twist angle 73 is then derived 730 which provides the required line-to-line distance 71. Finally the pulse rate target 734 is provided 733 based on the line-to-line density target 71, the accessed 210 object distance 21 and the scan rate 60. The pulse rate target 734 might be provided such that it oversamples the target, i.e. the pulse-to-pulse distance is a unit fraction of the line-to-line distance target 71.

Although aspects illustrated above, partly with reference to some specific embodiments, it must be understood that numerous modifications and combinations of different features of the embodiments can be made. All of these modifications lie within the scope of the appended claims.

1. Mobile scanning instrument configured to be mounted on a carrier vehicle, and configured to acquire point cloud data representing a target area at an object distance from the mobile scanning instrument whilst the carrier vehicle is travelling at a carrier velocity relative to the target area,
wherein the mobile scanning instrument exhibits a main axis and comprises
a pulse source unit configured to generate scanning pulses in a periodic manner having a pulse rate, and
a beam deflection element configured to define an actual transmission direction of the generated scanning pulses with respect to the main axis, wherein the actual transmission direction varies along a scan pattern in a periodic manner having a scan rate,
wherein the scanning instrument is configured
to offset the scan pattern with a twist angle representing a rotation about the main axis, and
to perform a twist angle optimization algorithm comprising
accessing input parameters comprising the pulse rate, the scan rate, the carrier velocity, and the object distance,
providing an optimization target representing a point density and/or a homogeneity of the point cloud data,
providing an output twist angle based on the optimization target and the input parameters.

2. The mobile scanning instrument according to claim 1 configured to be mounted to an aircraft, wherein the carrier velocity is a flight velocity over the ground, in particular wherein the main axis corresponds to a nadir direction.

3. The mobile scanning instrument according to claim 1, wherein
the scan pattern is a line pattern,
the scan rate and the carrier velocity define a line-to-line distance,
the pulse rate, the scan rate, and the object distance define a point-to-point distance, and
the optimization target is a threshold homogeneous point density of the point cloud data.

4. The mobile scanning instrument according to claim 3, wherein the twist angle optimization algorithm comprises
determining an effective line-to-line distance based on the line-to-line distance and the twist angle,
providing the optimal twist angle based on the effective line-to-line distance and the point-to-point distance, in particular by selecting the twist angle setting the effective line-to-line distance equal to a maximal point-to-point distance or to a point-to-point distance corresponding a point density target.

5. The mobile scanning instrument according to claim 1, wherein
the beam deflection element comprises a first wedge and a second wedge mounted along the main axis,
the first wedge is configured to rotate with a first wedge rate,
the second wedge configured to rotate with a second wedge rate, such that a ratio first and the second wedge rates is a proper fraction, in particular a root of unity.

6. The mobile scanning instrument according to claim 5, being configured to provide the twist angle based on a wedge phase shift representing a phase difference between a rotation of the first wedge and a rotation of the second wedge.

7. The mobile scanning instrument according to claim 1 being configured to provide a twist angle interval, wherein the scanning instrument is configured to offset the scan pattern with any twist angle within the twist angle interval.

8. The mobile scanning instrument according to claim 1, being configured to acquire point cloud data with the scan rate of at least 10 Hz.

9. A method of surveying by a mobile scanning instrument mounted on a carrier vehicle travelling with a carrier velocity a target area at an object distance from the mobile scanning instrument, the method comprising
generating scanning pulses in a periodic manner having a pulse rate,
transmitting the generated scanning pulses along an actual transmission direction with respect to a main axis, wherein the actual transmission direction varies along a scan pattern in a periodic manner having a scan rate,
acquiring return pulses from the target area and providing return pulse data regarding the acquired return pulses,
deriving the point cloud data representing the target area based on the return pulse data
performing a twist angle optimization, wherein the twist angle optimization comprises:
accessing input parameters comprising the pulse rate, the scan rate, the carrier velocity, and the object distance;
providing an optimization target representing a point density and/or a homogeneity of the point cloud data,
providing an output twist angle based on the optimization target and the input parameters, wherein a twist angle represents an offsetting of the scan pattern by a rotation about the main axis,
setting the twist angle to the output twist angle.

10. The method according to claim 9, wherein the optimization target is a highest achievable homogeneous point density of the point cloud data.

11. The method according to claim 9, wherein the method further comprises a task recognition, the task recognition comprises:
determining a type of the scan task, in particular by determining a representative object distance variation,
providing an assessment on the optimization target based on the determined scan task,
wherein feedback data is provided to a training procedure, the training procedure being based on a machine learning algorithm and providing update information for the task recognition, wherein the feedback data being provided by:
explicit feedback by means of the feedback procedure, in particular by an operator of the mobile scanning instrument, and/or
implicit feedback based on at least one of:
an interpretation of a lack of explicit feedback as a confirmation of the assignment,
a comparison of actual point cloud data, in particular a line-to-line distance, point-to-point distance, or swath width, with the assessed optimization target.

12. The method according to claim 9, wherein:
the surveying is an aerial scanning,
the carrier velocity is a flight velocity,
the main axis corresponds to a nadir direction, and
the method is performed relative to a reference frame defined by the flight velocity and the nadir direction, in particular in a zero twist state the scan pattern has a maximum extension in a direction perpendicular both to the nadir direction and the flight velocity.

13. The method according to claim 9, wherein the method further comprises
providing a pulse modulation arrangement, wherein the pulse modulation arrangement comprises
a pseudorandom component, and/or
a geometry dependent component provided on the basis of the actual transmission direction,
modulating the generation of the scanning pulse based on the pulse modulation arrangement.

14. The method according to claim 9, further comprising a post-processing, wherein
the post processing comprises a step of discarding and/or smoothing a major portion of the point cloud data in order to improve homogeneity,
the pulse rate is set to oversample the target area thereby allowing the post processing to be performed.

15. A computer program comprising program code which is stored on a machine-readable medium, or being embodied by an electromagnetic wave comprising a program code segment, and has computer-executable instructions for performing a twist angle optimization algorithm for a mobile scanning instrument mounted on a carrier vehicle, wherein the mobile scanning instrument is configured to:
generate scanning pulses in a periodic manner having a pulse rate,
transmit the generated scanning pulses along an actual transmission direction with respect to a main axis, wherein the actual transmission direction varies along a scan pattern in a periodic manner having a scan rate,
acquire return pulses from a target area and provide return pulse data regarding the acquired return pulses,
derive point cloud data representing the target area based on the return pulse data; and
wherein the twist angle optimization algorithm comprises:
accessing input parameters comprising the pulse rate, the scan rate, a carrier velocity, and an object distance;
providing an optimization target representing a point density and/or a homogeneity of the point cloud data,
providing an output twist angle based on the optimization target and the input parameters, wherein a twist angle represents an offsetting of the scan pattern by a rotation about the main axis.
